(19) United States
(12) Patent Application Publication
(10) Pub. No.: US 2011/0013859 A1
(43) Pub. Date: Jan. 20, 2011

(54) Side fold sack with roll bottom

(75) Inventor: Uwe Koehn, Osnabrueck (DE)

Correspondence Address: JACOBSON HOLMAN PLLC, 400 SEVENTH STREET N.W., SUITE 600, WASHINGTON, DC, 20004, US

(73) Assignee: WINDMOLLER & HOELSCHER

(21) Appl. No.: 12/659,351

(22) Filed: Mar. 4, 2010

Related U.S. Application Data
(63) Continuation of application No. 11/136,724, filed on May 25, 2005, now abandoned.

(51) Int. Cl. B65D 30/20; B31B 1/26; B31B 1/62

(52) U.S. Cl. 383/120; 493/243; 493/264

(57) ABSTRACT

A side fold sack of polyolefin material that includes a tubular segment having side folds between front and rear walls of the tube. The bottom of the sack exhibits at least one fold of the tubular segment made at 180° about an axis which is generally transverse to the side folds. At least part of the folded area is covered with a label that provides support to the bottom of the sack.

This application is a continuation application of co-pending application Ser. No. 11/136,724, filed Mar. 25, 2005,and hereby claims the priority thereof to which it is entitled.

### BACKGROUND OF THE INVENTION

1. Field of the Invention

The invention relates to sacks made from polyolefin material, which exhibit features including an area of a tubular segment, with front walls and side walls of the sack, whereby the side walls exhibit side folds, and a bottom area at an end of the area of the tube segment, which exhibits at least one fold of the tube piece material made at 180° about the axis, which runs essentially transversely to the side folds.

Description of the Related Art

Such type of sacks are known. Of these, sacks made from polyolefin material are particularly “firm” or shape-sustaining and, for this purpose, the polyolefin fibers are in general textured and oriented mostly monoaxially, that is along their longitudinal axis. These fibers are often entwined into flat sheets, from which tubes are later produced. However, the fibers can be processed directly to round tubes. This polyolefin material and its properties are well-known and are explained in, besides other publications, WO 95/30598. Further processing of this material requires in-depth know-how. For instance, DE 101 06 289 A1 shows such a sack. Among the disadvantages of the sacks fabricated with this type of simple fabrication procedure is that the bottom fold opens up when the filled sack is stacked and the fold is exposed directly to mechanical load. Such mechanical load can be created by another heavy, filled sack being dragged over this bottom fold, leading to breaking open of the fold. Therefore, the underlying problem of the invention was to propose a sack, in which the bottom area exhibits greater durability. This problem is solved by a side fold sack made from polyolefin material and including a tubular segment, with front walls and side walls of the sack, whereby the side walls exhibit side folds, and a bottom area at an end of the area of the tubular segment. The bottom area exhibits at least one fold of the tube piece material made at 180° about the axis, which runs essentially transversely to the side folds. According to the present invention, a label covers at least part of the folded area to provide support to the bottom of the sack.

### SUMMARY OF THE INVENTION

Among the other advantages of a sack according to the present invention is that, due to the presence of the bottom cover, the filled sack readily assumes a cuboid or a box-shaped form.

Sacks made from polyolefin material and provided with a label are particularly shape-sustaining due to the monoaxial orientation of the polyolefin fibers.

Thus, because the polyolefin fibers are in general textured and oriented mostly monoaxially, that is along their longitudinal axis, it is necessary to follow certain processing steps during the welding of these sacks, in order to not lose the shape-retaining firmness of the oriented material. The aforementioned publication in the Description of the Prior Art section also contains the details about that topic as well as about the used temperature ranges.

A heat induced seaming procedure in connection with the processing of the sack according to the invention is especially of advantage. Heat induced seaming means here a method of bonding, which requires supply of heat. That is, even a gluing method, which is carried out with temperature-dependent adhesives also belongs to a heat induced bonding method. The same applies to any other type of processing of the extrudates.

Especially advantageous among heat induced seaming methods are the joint welding methods, in which the polyolefin fabric is bonded. Thereby, attention must be paid, as mentioned, that the firmness or shape-retaining characteristic of the polyolefin fabric does not get impaired due to monoaxial orientation of the macromolecules in polyolefin bands.

A further advantageous possibility in the processing of this material lies in that, the coating, which is often made on polyolefin band tissues, is welded. The fabric is often coated in order, in particular, to make the tissue more tight against leakage when filled with pulverizable material.

The sack according to the present invention exhibits a bottom fold, which is made about an axis, which is essentially transverse to the axis of the tubular segment or an area of tubular segment. Such a fold or a rolling is not easy to make. Even this fold or the rolling contributes to the subsequent box-like shape of the filled up sack and is therefore of special advantage. With a double fold, not only the stability, but also the sack's tightness in the bottom area is increased considerably and to a surprisingly remarkable extent. The double fold leads to a still stronger bottom, which also supports the box-like shape of the sack especially in conjunction with the label. During the deposition of the label, care must be taken that at least parts of the bottom fold are covered with the label, so that the fold is supported by the label. Depending on the label, however, it can be adequate, if most of the areas remain unsupported and if the labels, for example, in the form of adhesive bands, cover only some parts of the areas of the fold.

### BRIEF DESCRIPTION OF THE DRAWINGS

FIG. 1 is a perspective view of a tube or segment of the tube in the fabrication of a sack according to the invention.

FIG. 2 is a side view of a segment of the tube, in which an end is rolled inwards.

FIG. 3 is a top view of an end of a sack according to the invention.

FIG. 4 is a side view of an end of a sack according to the invention.

### DETAILED DESCRIPTION OF THE PREFERRED EMBODIMENTS

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

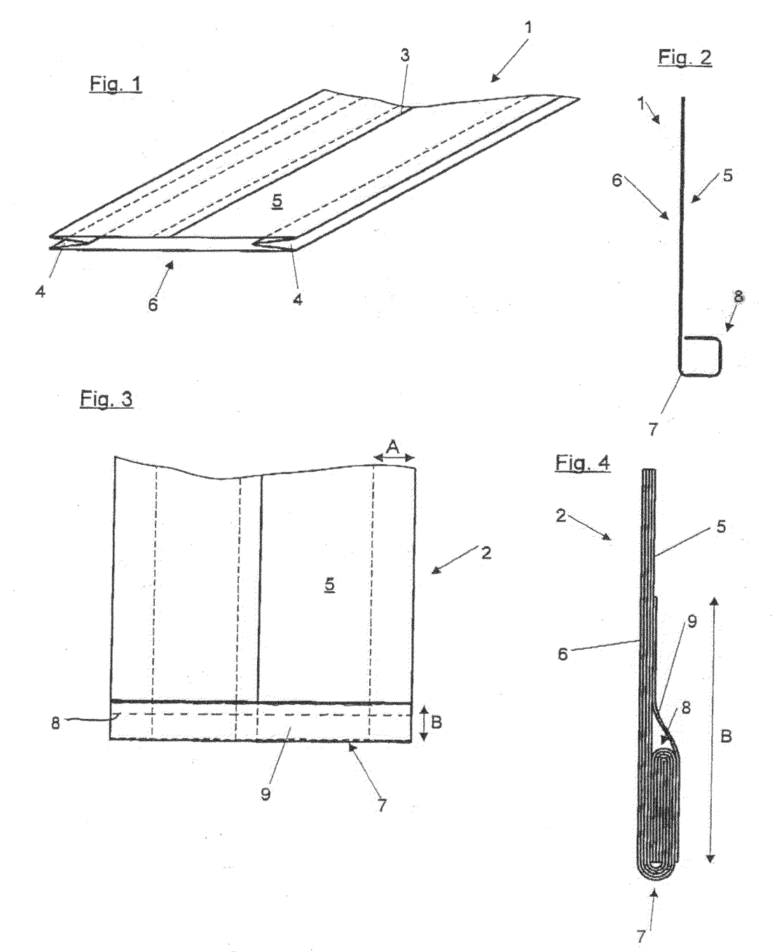

FIG. 1 shows a perspective view of a tube 1 or a tubular segment, which is suitable for the fabrication of a sack 2 according to the invention. In the exemplary embodiment, the tube 1 exhibits a longitudinal seam 3. As a rule, the tubes are in general fabricated with such a lengthwise seam from a flat sheet. Alternatively, the tube 1 can also be of a round shaped material, so that no lengthwise seams are there. The tube 1 shown in FIG. 1 exhibits side folds 4, made with depth A (see FIG. 3), between the front wall 5 and the real wall 6 of the tube 1.

One step in the fabrication process of the sacks 2 according to the invention is illustrated in FIG. 2. About one axis (7), which runs transversely to the lengthwise seam 3 and lies in the plane parallel to the walls 5 and 6 of the tube, the lower end of the tube 8 is folded or rolled. Thereby, the folded end 8 of the tube comes to lie against the front wall 5 of the tube 1 or the sack 2 (as shown) or on the rear wall 6 (not shown). In each, two layers, which are laid one above the other by folding over or rolling, can be connected through an appropriate bonding process.

After the rolling up or folding of the end 8, a label 9 is connected with the folded end 8, and on the wall, on which the fold or the roll lies. In the example shown in FIGS. 3 and 4, the label 9 is connected with the lower end 8 and with the front wall 5. The label 9 extends over the entire length of the sack 2 or the tube 1. In the shown exemplary embodiment, the width B of the label 9 is somewhat smaller than the depth A of the side folds. If the width of the label 9 is smaller than or equal to the depth A and the side edge of the label 9 is arranged near the fold—or the axis (7) of the roll, then the label 9 lies exclusively at the bottom area of the sack, if it assumes, for example due to filling, a block-like shape. In that case, the bottom is also very resilient against mechanical loads, even when the sack is filled up. In order to improve the firmness further, it can be so provided, that the rolled up or the folded end 8 extends over half of the width B of the label 9.

The invention being thus described, it will be apparent that the same may be varied in many ways. Such variations are not to be regarded as a departure from the spirit and scope of the invention, and all such modifications as would be recognized by one skilled in the art are intended to be included within the scope of the following claims.

1. A side fold sack made from polyolefin material, comprising:
a tubular segment having a front wall, a back wall and side walls to form the sack, said side walls including side folds having a fold depth;
a first bottom fold at the lower end of the tubular segment material made at 180° about a bottom fold axis toward the front wall to form a folded portion and a second fold of said folded portion made inwardly at 180° toward the bottom fold axis and against the front wall about an axis which runs essentially transverse to the side folds to form a bottom folded area, said bottom fold axis extending essentially transversely to the side folds, each of said folds being connected to the front wall by a bonding process; and
a label covering at least a part of the bottom folded area and having a width that extends substantially transversely to said bottom fold axis, said label width being less than or equal to said side fold depth.

2. The side fold sack according to claim 1, wherein the sack material includes fabrics of oriented polyolefin material.

3. The side fold sack according to claim 1, wherein the label is joined with at least one wall of the tubular material and/or with the bottom folded area by a joint that is heat induced.

4. (canceled)

5. The side fold sack according to claim 1, wherein the label is joined with the front wall of the sack.

6. The side fold sack according to claim 1, wherein the label is located adjacent the bottom fold axis.

7. The side fold sack according to claim 1, wherein the bottom folded area extends under more than half of the label width.

8. A method for fabrication of side fold sack, comprising providing a segment of a tubular piece of material having side folds, folding an end of said side folded tube segment at 180° about a bottom axis which is essentially transverse to the side folds to form a folded portion and then folding the folded portion upon itself toward said bottom axis about a second axis which runs essentially transverse to the side folds to form a bottom folded region, and covering at least a part of the bottom folded region with a label having a width less than or equal to a depth of said side folds.

9. The method according to claim 8, further comprising the step of forming a bond between the folded tubular segment material and at least one wall of the tubular segment after each fold, said bond being heat induced at least in part.

10. The method according to claim 8, further comprising making a coating on the sack material and bonding said coating with a coating on said label by melting with heat.

11. The method according to claim 8, wherein the sack is made from a tube segment made from a tube with staggered cuts and/or straight cuts.

12. A side fold sack made from polyolefin material, comprising:
a sack having front and back walls and side walls that include side folds having a fold depth;
a bottom end of said sack being closed by a first bottom fold made at 180° about a bottom fold axis that extends essentially transversely to the side folds to form a folded portion and a second fold of said folded portion made inwardly at 180° toward the bottom fold axis about a second axis that is substantially parallel with said bottom fold axis to form a bottom folded area; and
a label covering at least a part of the bottom folded area and having a width that extends substantially transversely to said bottom fold axis, said label width being less than or equal to the side fold depth.

13. The side fold sack according to claim 12, wherein the sack is made from a tubular segment.

14. The side fold sack according to claim 12, wherein the sack material includes fabrics of oriented polyolefin material.

15. The side fold sack according to claim 12, wherein the label is joined with at least one of the front and back walls of the sack by a joint that is heat induced.

16. The side fold sack according to claim 13, wherein the label is joined with at least one wall of the tubular segment and/or with the bottom folded area by a joint that is heat induced.

17. (canceled)

18. The side fold sack according to claim 12, wherein the label is joined with one of the front wall or the back wall of the sack.

19. The side fold sack according to claim 12, wherein the label is located adjacent the bottom fold axis.

20. The side fold sack according to claim 12, wherein the bottom folded area extends under more than half of the label width.

21. The side fold sack according to claim 12, wherein the sack is made from a flat sheet.

22. The side fold sack according to claim 12, wherein the label is made of the same material as the sack, said material including coated fabrics made of polyolefin fibers.
